(19) United States
(12) Patent Application Publication
(10) Pub. No.: US 2011/0238826 A1
(43) Pub. Date: Sep. 29, 2011

(54) METHOD AND SYSTEM FOR ANALYSING A MOBILE OPERATOR DATA NETWORK

(75) Inventors: Nicolas Carre, Montreal (CA); Jean-Philippe Goyet, Montreal (CA); Eric Melin, Montreal (CA)

(73) Assignee: NEURALITIC SYSTEMS, Montreal, QC (CA)

(21) Appl. No.: 13/133,113

(22) PCT Filed: Dec. 8, 2009
(86) PCT No.: PCT/CA2009/001790

§ 371 Date: Jun. 6, 2011

Related U.S. Application Data
(62) Division of application No. 61/120,700, filed on Dec. 8, 2008.
Application No. 61/120,700 is a division of application No. 61/154,107, filed on Feb. 20, 2009.

(51) Int. Cl. G06F 15/173

(52) U.S. Cl. 709/224

(57) ABSTRACT

The present method and system relate for analyzing a mobile operator data network. The method and system dynamically collect and record information of mobile devices from Internet Protocol data sessions occurring on the mobile operator data network. The collected information is processed to detect and record at least one change in one of the mobile devices with a date of occurrence. The method and system then analyze the collected information and the recorded at least one change to generate metrics representative of evolution on the mobile operator data network.

### FIELD

The present method and system generally relate to analysis of mobile operator data network. More specifically, the present method and system analyses amongst other things relative portfolio share of mobile devices with data capabilities, based on real time information extracted from a Mobile Operator data network. Additionally, the impact of specific features of the mobile devices, including among others the operating system and data rate, are also analyzed. The present method and system offer a snapshot of the portfolio shares at a given time, or their evolution over a specific duration. Furthermore, the usage of mobile data services is compared between different models of mobile devices.

### BACKGROUND

The competition between Mobile Operators is becoming increasingly intense and complex, especially with the advent of advanced mobile data services offering multiple opportunities to differentiate and compete amongst Mobile Operators.

Each Mobile Operator needs to implement strategies to maintain or even increase the number of its subscribers and the Average Revenue Per User (ARPU). One way to do this is to introduce new mobile devices, with characteristics and capabilities that are expected to appeal to current subscribers and potential new subscribers. Furthermore, mobile devices with advanced capabilities for mobile data services are considered as a good incentive to boost the ARPU.

The most common types of mobile data services offered over mobile IP networks include web browsing and e-mails. However, for corporate subscribers, advanced mobile data services offerings, with almost the same level of functionalities on the move, compared to those available at the office, are proposed by Mobile Operators. These functionalities include Virtual Private Networks (VPN), access to corporate productivity applications, on-line collaboration, and secure e-mail access. For subscribers interested in fancy multimedia capabilities, a whole set of services including music delivery, video delivery, television, social networking, on-line gaming, are supported by the latest generation of mobile devices.

In this context, a Mobile Operator may decide to distribute a specific mobile device, with a set of features expected to support the Mobile Operator strategy in terms of consumer gains or ARPU increase. The device form factor and the strength of its manufacturer brand are also very important parameters to take into account. The Mobile Operator may even consider having the exclusivity on a highly popular mobile device, to further increase its impact, by making it available to its subscribers only. Alternatively, the Mobile Operator may also select various mobile devices from different manufacturers, with specific characteristics that have been identified as a must have, in the context of the delivery of advanced mobile data services.

A critical point for the Mobile Operator is the ability to assess the impact of a specific marketing strategy, for instance the launch of a new high-end mobile device. Generally speaking, the Mobile Operator would benefit from having metrics to track the evolution of the portfolio share of various mobile devices on a regular (daily, weekly, monthly) basis. Using historic data, it would be interesting also to better understand the impact of the introduction of former mobile devices, in order to anticipate the impact of new mobile devices with similar characteristics.

Another critical point for the Mobile Operator is the ability to analyze the impact of specific models of mobile devices on the mobile data services consumption: compare usage of a selected list of mobile data services (in terms of volume of data exchanged, number of unique subscribers using the service, frequency of use) for different models of mobile devices. For this purpose, it is necessary to memorize over time the mobile data services consumption of the subscribers, to memorize the models of mobile devices used by the subscribers, and to perform a correlation between the mobile data services consumed and the models of mobile devices used for this purpose.

Currently, a Mobile Operator only has a static and partial view of the respective portfolio shares of various data enabled mobile devices using its network. For instance, the information system of the Mobile Operator keeps track of the mobile devices which have been purchased by its subscribers directly from the Mobile Operator. However, it does not take into account the mobile devices purchased from other sources (usually referred to as the grey market), resulting in the Mobile Operator not knowing which mobile device is used by some subscribers. Also, roaming users are not taken into account by the aforementioned information system. Thus, the Mobile Operator information system may not take into account the mobile devices using the mobile data network, for a percentage of users as high as ten or even twenty percent of the total number of users. In this case, the metrics based on the Mobile Operator information system could be at best approximate, and even totally inaccurate.

Another drawback of the data that is extracted from the Mobile Operator information system is that it is static. Knowing that a subscriber purchased a specific mobile device is not sufficient. It gives no information on when it is effectively used on the Mobile Operator data network. Also, when a subscriber changes its mobile device, the information system of the Mobile Operator does not keep track of the previously used mobile device.

The last point is that the data that can be extracted from an information system varies greatly in terms of format, completeness, from one Mobile Operator to another. This would make it difficult to have a generic analytic system performing the type of portfolio share analysis mentioned before. Some customization would be necessary for each Mobile Operator, to interface a generic analytic system with its proprietary information system. Also, to have a good granularity, information would have to be extracted at least on a daily basis, which may add additional constraints on the information system.

Therefore, there is a need of overcoming the above discussed issues concerning the availability of exhaustive, real time data. Accordingly, a method and system for analyzing mobile devices portfolio share on a Mobile Operator data network are sought.

An object of the present method and system is therefore to analyze mobile devices portfolio share on a Mobile Operator data network. Another object is to keep track and use the history of a subscriber in terms of owned mobile devices to generate interesting metrics and to evaluate portfolio share gains and losses.

The foregoing and other objects, advantages and features of the present method and system will become more apparent upon reading of the following non-restrictive description of any illustrative embodiments thereof, given by way of example only with reference to the accompanying drawings.

### BRIEF DESCRIPTION OF THE DRAWINGS

In the appended drawings:

FIG. 1 illustrates a method and system for analyzing mobile devices portfolio share on a Mobile Operator data network, according to a non-restrictive illustrative embodiment;

FIG. 2 illustrates a type of report that is generated by the analytic system performing mobile devices portfolio share analytics, according to a non-restrictive illustrative embodiment;

FIG. 3 illustrates another type of report that is generated by the analytic system performing mobile devices portfolio share analytics, according to a non-restrictive illustrative embodiment;

FIG. 4 illustrates another type of report that is generated by the analytic system performing a correlation between mobile data services usage and models of mobile devices, according to another non-restrictive illustrative embodiment;

FIG. 5 illustrates the system architecture of the analytic system performing mobile devices portfolio share analytics, according to a non-restrictive illustrative embodiment.

### DETAILED DESCRIPTION

In a general embodiment, the present method is adapted for analyzing a mobile operator data network. For doing so, the method dynamically collects information of mobile devices from Internet Protocol data sessions occurring on the mobile operator data network. The method records the collected information in a database, and processes the collected information to detect at least one change in one of the mobile devices. Then, the method records the at least one change for the corresponding mobile device and a date of occurrence. Then method further analyses the collected information and the recorded at least one change to generate metrics representative of evolution on the mobile operator data network.

In another general embodiment, the present system is adapted for analyzing a mobile operator data network. For doing so, the system comprises a pre-processing unit, a database and an analytic engine. The pre-processing unit is adapted for receiving dynamically collected information of mobile devices from Internet Protocol data sessions occurring on the mobile operator data network. The pre-processing unit further detects at least one change in one of the mobile devices and records the at least one change for the corresponding mobile device with a date of occurrence. The database is adapted for recording the collected information, the at least one change for the corresponding mobile device and the date of occurrence. The analytic engine is adapted for analyzing the collected information and the recorded at least one change to generate metrics representative of evolution on the mobile operator data network.

Generally stated, a non-restrictive illustrative embodiment of the present is a method and system to generate metrics related to the type of mobile devices used on a Mobile Operator data network. The goal of these metrics is to help the Mobile Operator better follow the portfolio share of a specific mobile device model, a group of mobile devices models, or a manufacturer. The metrics can also focus on specific characteristics of data enabled mobile devices. For instance, following the evolution of the portfolio share of mobile devices with a given operating system, a given data rate, a given form factor, etc.

Additionally, a method and system according to a non-restrictive illustrative embodiment of the present relies on a filtering system for extracting real time information from the Mobile Operator data network. The information consists essentially in reporting the model of the mobile device used by a subscriber performing a data session. This information is transmitted to a centralized analytic system. The filtering system relies on Deep Packet Inspection (DPI) technologies or any other similar technology, which has the capability to extract relevant information directly from Internet Protocol (IP) based data sessions of active subscribers.

Furthermore, a method and system according to a non-restrictive illustrative embodiment of the present relies on an analytic system to process, memorize and analyze the information transmitted by the filtering system. The analytic system records the historic of the models of mobile devices used by the subscribers. The analytic system also computes metrics related to the portfolio share of the models of mobile devices used on the Mobile Operator data network.

Moreover, a method and system according to a non-restrictive illustrative embodiment of the present enables a correlation of the mobile data services usage with models of mobile devices used by subscribers. For this purpose, the filtering system also extracts real time information related to the mobile data services usage of the subscribers and transmits them to the analytic system. The analytic system memorizes this information, and computes metrics to correlate the mobile data services usage with the models of mobile devices.

Also, a method and system according to a non-restrictive illustrative embodiment of the present allow for presenting the metrics to the Mobile Operator in the form of customizable reports. These reports give a snapshot of the portfolio share of the selected items at a given time. The reports also provide the evolution of the portfolio share of the selected items over a given period, and a correlation between the mobile data services usage and the models of mobile devices.

The reports generated by the present method and system enable Mobile Operators to follow trends, knowing which mobile devices have a growing popularity and which have a declining popularity. Also the attractiveness of specific capabilities of advanced data enabled mobile devices can be evaluated. These are powerful tools to help Mobile Operators offer the kind of mobile devices that have a positive impact on subscriber retention/gain, and also on mobile data ARPU increase. Furthermore, the history of a subscriber in terms of owned mobile devices can be used to generate interesting metrics, to evaluate portfolio share gains and losses.

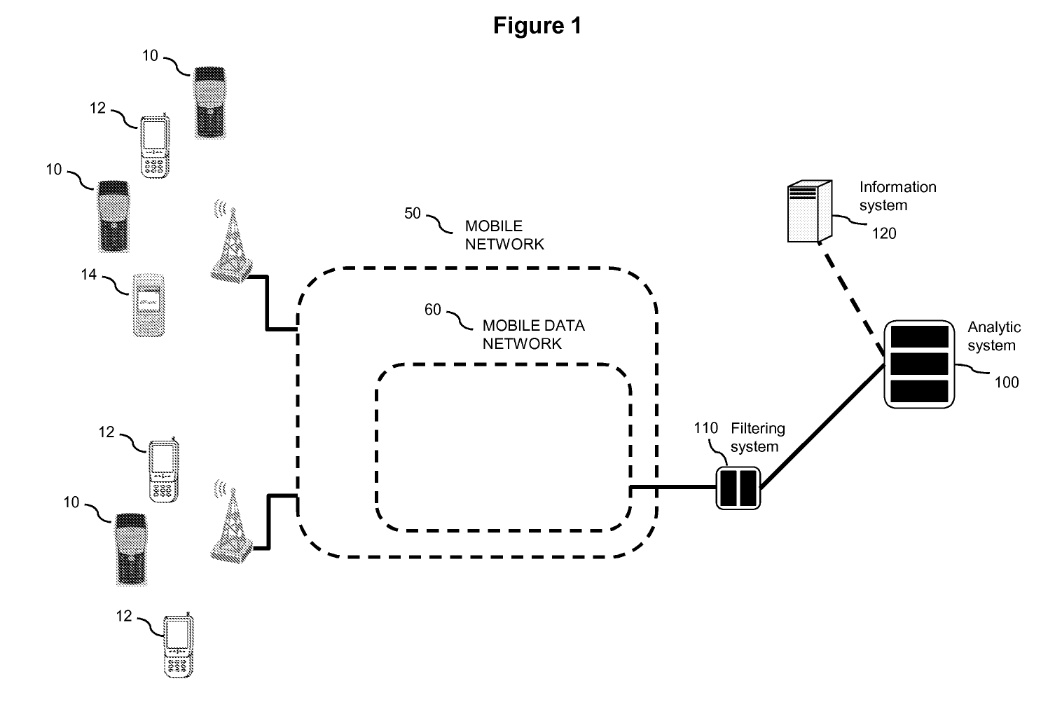

FIG. 1 illustrates a method and system for analyzing mobile devices portfolio share on a Mobile Operator data network.

A mobile network 50 owned by a specific Mobile Operator is considered in FIG. 1. Examples of such mobile networks include cellular networks implementing one of the following standards: General Packet Radio Service (GPRS), Universal Mobile Telecommunication System (UMTS), Code Division Multiple Access 2000 (CDMA 2000), and the future Long Term Evolution (LTE) standard. Worldwide Interoperability for Microwave Access (WIMAX) networks are another type of mobile networks that can be considered. The mobile network 50 is usually operated over a whole country, but could also cover a specific administrative region or geographic area in one or several countries.

Subscribers use different types of mobile devices 10, 12, 14 to operate on the mobile network 50. Each mobile device has two related characteristics: its manufacturer and a specific model within the manufacturer product range.

The mobile network 50 comprises a mobile data network 60, to transport the data traffic generated by the mobile data services provided by the Mobile Operator. Such mobile data services consist, among others, in web browsing, e-mail, multimedia delivery, social networking, on-line gaming, corporate mobile data applications, etc. The Internet Protocol (IP) is the underlying networking protocol used in mobile data networks, in the case of any type of cellular network as well as for WIMAX networks.

A filtering system 110 is connected to the mobile data network 60 and has the capability to capture the IP traffic generated by data sessions of the mobile devices 10, 12, 14. The filtering system 110 is based on a technology well known in the art: Deep Packet Inspection (DPI). DPI consists in capturing IP based data traffic, analyzing the different IP protocol layers (network, transport, session, application . . . ), and extracting relevant information from these protocol layers. The filtering system 110 is deployed in a strategic location of the mobile data network 60: a place where all IP based data sessions converge and are aggregated, before accessing external IP networks like the Internet. This location is usually referred to as the IP Core Network of the Mobile Operator, by contrast to the Radio Access Network. The advantage of deploying the filtering system in the IP Core network is that one to a few instances will be sufficient to monitor all the IP based data traffic. By comparison, deploying the filtering system in the Radio Access Network would require hundreds and even thousands of instances.

To illustrate how the filtering system 110 operates, details will now be provided in the case of a UMTS cellular network. For a UMTS cellular network, the best point of capture for the filtering system 110 is the Gn interface of the Gateway GPRS Support Node (GGSN). Each (incoming or outgoing) data session goes through the Gn interface. The GPRS Tunneling Protocol (GTP) is used to transport the IP based data sessions of the subscribers on the Gn interface of the GGSN. The GTP protocol has a user plane to transport the IP based data and a control plane to manage the data sessions of each subscriber. A unique identifier of the mobile device used by the subscriber can be extracted from the GTP control plane: the International Mobile Equipment Identity (IMEI). This identifier can be used to identify the manufacturer and model of the mobile device: the IMEI is composed of a sub-section identifying the manufacturer, a sub-section identifying the specific model within the manufacturer portfolio of mobile devices, and a sub-section identifying the specific mobile device owned by the subscriber. Additionally, a unique identifier of the subscriber can be extracted from the GTP control plane: the International Mobile Subscriber Identity (IMSI). Thus, for each IP based data session on the Gn interface of the GGSN, the filtering system 110 uses its DPI capabilities to extract the related IMEI and the IMSI. This information is transmitted to an analytic system 100, with a timestamp indicating the date and time of the session.

Alternatively, the Gi interface of the GGSN can be used for a UMTS cellular network. In this case, the IMEI and IMSI related to an IP based data session can be extracted from Remote Authentication Dial In User Service (RADIUS) messages used for authentication, authorization and accounting purposes. The filtering system 110 analyzes the RADIUS messages to extract the relevant information. In the RADIUS messages, the IMSI may not be available, in which case it is replaced by the Mobile Subscriber ISDN (MSISDN—mobile phone number), to uniquely identify the subscribers.

Although the filtering system 110 has been described in the context of a UMTS network, the principles of operation may be generalized to any type of mobile network. For each IP based data session, an identifier of the mobile device being used and an identifier of the subscriber are extracted. An identifier of the subscribers (like the IMSI or MSISDN in the case of an UMTS network) is always present in the IP based data sessions (monitored by the filtering system 110), since it is a critical information for the authentication, authorization and billing of the subscribers. Regarding the identifier of the mobile devices (like the IMEI in the case of an UMTS network), it is also always present in the IP based data sessions (monitored by the filtering system 110). In the case of cellular networks like UMTS, CDMA2000, and LTE, it is the IMEI or an equivalent. In the case of a WIMAX network, it is the Media Access Control (MAC) address of the terminal. In both cases (IMEI or MAC address), the manufacturer and model of a mobile device can be extrapolated from this identifier.

Reverting to FIG. 1, assuming that all the mobile devices represented on FIG. 1 are engaged in a data session, the filtering system 110 reports the following information to the analytic system 100: seven different subscribers have performed a data session, three of them using the mobile device of model 10, three of them using the mobile device of model 12, and one of them using the mobile device of model 14. As mentioned before, the identifier of each subscriber and a timestamp for each data session are transmitted as well.

The analytic system 100 receives the information extracted by the filtering system 110 on a regular basis, for instance every day or every week, based on the Mobile Operator needs. In a typical deployment, a single instance of the analytic system 100 is in operation. It may be necessary to deploy several filtering systems 110, at different points of capture in the mobile data network 60. In this case, the information reported by the different filtering systems 110 is aggregated by the analytic system 100.

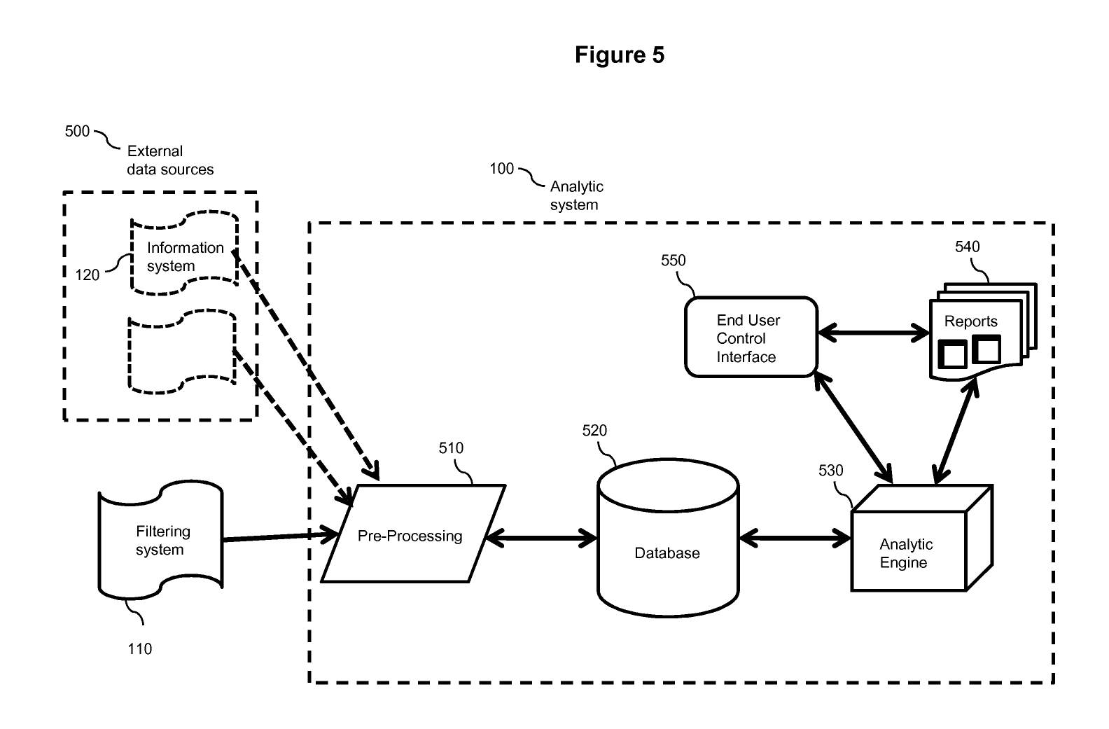

As illustrated in FIG. 5, the analytic system 100 comprises a pre-processing unit 510 and a database 520. The pre-processing unit 510 is in charge of receiving the data from the filtering system(s) 110, processing this data, and updating the database 520 when necessary. The database stores amongst other things, the evolution of the models of mobile devices used by each subscriber of the Mobile Operator over time.

The data received by the pre-processing unit 510 consists in a flat file, each entry of the flat file containing: a subscriber identifier, a mobile device identifier, and a timestamp. Each entry of the flat file corresponds to an IP based data session monitored by the filtering system 110 of FIG. 1, as explained previously. For each entry in the flat file, the pre-processing unit 510 extracts from the database 520 the identifier of the model of mobile device currently in use for the subscriber identified by the subscriber identifier in the flat file entry. If the identifier of the model of mobile device in the flat file entry differs from the one extracted from the database, the pre-processing unit infers that the subscriber has changed its mobile device. Thus, the pre-processing unit updates the database with the identifier of the new model of mobile device used by the subscriber, with the related timestamp to identify the date at which the update occurred. As previously mentioned, the mobile device identifier is composed of a sub-part identifying the manufacturer and a sub-part identifying a precise model within the manufacturer portfolio. The pre-processing unit also updates the database with the name of the manufacturer and the name of the model associated to the identifier of the mobile device. The pre-processing unit 510 uses the identifiers of the mobile devices to query the database 520, while an analytic engine 530 uses the names of the manufacturers and the names of the models for its queries to the database 520. Since the analytic engine 530 is controlled by the end users via an end user control interface 550, the identifiers of the mobile devices cannot be used, because they have no meaning for the end users, who only understand the names of the manufacturers and the names of the models.

The correlation between the names and the identifiers of the mobile devices is obtained from external sources, usually the mobile devices manufacturers or third party suppliers. The correlation data is stored in the pre-processing unit 510 or in the database 520, and is updated regularly with the correlation data for the new mobile devices which appear on the market. The update is performed manually by a system administrator, or is automated if a reliable source can be automatically queried to obtain the information.

For each subscriber of the Mobile Operator data network, the database 520 keeps track of the currently used model of mobile device, and also records the previously used models. The database 520 contains all the subscribers to the Mobile Operator data network, and is updated when new subscribers register with the Mobile Operator data network. The database 520 may be a dedicated database specifically put in place for the purpose of the present method and system, or an existing database containing information on all the subscribers extended to support the functionality of the present method and system. The index used to identify a specific subscriber in the database 520 is the unique identifier of the mobile devices collected by the filtering system 110 (for example, the IMSI or the MSISDN for an UMTS cellular network).

An algorithm is implemented in the pre-processing unit 510, to detect a transition between a previous and a new model, in case the subscriber is still using both mobile devices for a limited duration. The objective is to record in the database 520 only effective changes of mobile devices, and to detect temporary flip-flops between a previous and a new model. The algorithm can also be used to detect the case where one subscriber has two different mobile devices, for instance one for its work and one for its personal use.

Optionally, the analytic system 100 may also keep track of the roaming mobile devices present on the Mobile Operator data network 60. The filtering system 110 captures the identifiers of the roaming mobile devices (and the identifiers of their models of mobile devices) in the same manner as the identifiers of the mobile devices subscribed to the Mobile Operator data network. The first time a roaming mobile device is detected on the mobile operator data network 60, the pre-processing unit 510 queries the database 520 and obtains no answer for the identifier of the roaming mobile device. It infers that the mobile device is a roaming mobile device. Upon this first detection of the roaming mobile device, the pre-processing unit 510 adds the roaming mobile device to the database 520, with a specific flag indicating it is roaming. It also records the identifier of the model of mobile device that the roaming mobile device is currently using. After this operation, the roaming mobile device is treated as a mobile device subscribed to the mobile operator data network 60. If the roaming mobile device is detected again later on the mobile operator data network 60, the pre-processing unit 510 is capable of identifying the latter by interrogating the database 520 with its identifier. This is a means of having reliable statistics on the roaming mobile devices: if a roaming mobile device is detected consecutively five times on the mobile operator data network with the same model of mobile device, a single instance of the model of mobile device is recorded in the database 520 in relation to this specific roaming mobile device. Consequently, the analytic engine 530 represented on FIG. 5 generates metrics related to the mobile devices portfolio share, taking into consideration the subscribers of the Mobile Operator data network only, the roaming mobile devices only, or a combination of the roaming mobile devices and the subscribed mobile devices.

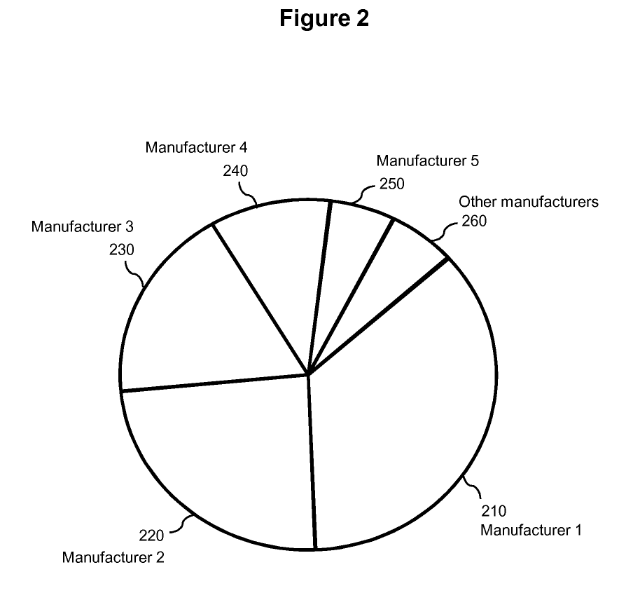

The analytic system 100 generates metrics related to the evolution of the models of mobile devices used on the mobile data network 60. Specifically, the analytic engine 530 represented on FIG. 5 is the entity responsible for computation of the metrics. These metrics are further processed to generate reports, which are presented to the Mobile Operator via a Graphical User Interface. An example of such reports consists in a dashboard comparing the portfolio share evolution of several pre-selected models of mobile devices. The metrics and the associated reports will be further detailed when describing FIG. 2.

To generate the metrics, data are extracted from the database 520, aggregated when needed, and some computation is performed to obtain the final metric. One option is to have the database 520 perform the three operations (extraction, aggregation, computation) under the control of the analytic engine 530. Alternatively, the database 520 only performs extraction and basic computations, while the aggregation and more sophisticated computations are performed by the analytic engine 530. Two types of metrics are generated: static and dynamic.

Following is an example of a static metric and how it is generated by the analytic engine 530. The metric considered is the portfolio share of each manufacturer in percentage, at a specific day. Every night, the analytic engine 530 computes this metric for the previous day and stores the result in the database 520. To compute the metric, the analytic engine 530 generates requests to the database 520 to calculate the total number of mobile devices for each manufacturer, for the day considered. The analytic engine 530 transforms the numbers for each manufacturer in a percentage of the total number of mobile devices and the resulting metrics are stored in the database 520 with a timestamp to identify the day at which the computation has been performed. Additionally, the request to the database 520 may include a parameter to perform the computation for the mobile devices subscribed to the Mobile Operator data network 60 only, for the roaming mobile devices only, or for the combination of the subscribed and roaming mobile devices. Reports based on this metric are generated on demand (for the end users) by the analytic engine 530. For example, the analytic engine 530 extracts from the database 520 the metrics for a given day, to present a report with the portfolio share of each manufacturer expressed in percentage for the day in question. In another example, the analytic engine 530 extracts from the database 520 the metrics for a subset of manufacturers for each consecutive days representing a period of time (for instance a month), to present a report with the comparison of the evolution day-by-day of the portfolio share of the selected manufacturers over the selected period of time. Another static metric is the portfolio share of each specific model of mobile device in percentage, at a specific day. This metric is generated using the same principles as for the manufacturer portfolio share metric.

A dynamic metric is a metric that is not part of the pre-defined metrics supported by the analytic engine 530. It is computed to generate an ad-hoc report defined dynamically by an end user. The dynamic metric does not benefit from intermediate computations performed every day by the analytic engine 530, as described for a static metric. All the operations necessary to generate the metric (extraction, aggregation, computation) are executed in real time. Thus, such a dynamic metric is usually more demanding in terms of processing power and requires a longer delay to be generated. An example of a dynamic metric is the portfolio share (in absolute value and in percentage) of all mobile devices with a WIFI connection (assuming that this metric has not been included in the list of static metrics computed every day by the analytic engine). For demonstration purposes, upon receipt of a request from an end user for a report showing the evolution of this metric on a three months period, the analytic engine 530 sends a request to the database 520, to calculate the number of mobile devices with a WIFI connection for every day in the three months period, and also to calculate the percentage of mobile devices with a WIFI connection reported to the total number of mobile devices for every day. Then, the analytic engine 530 generates a report with the calculated metric (absolute value and percentage) for each day in the three months period, to be presented to the end user.

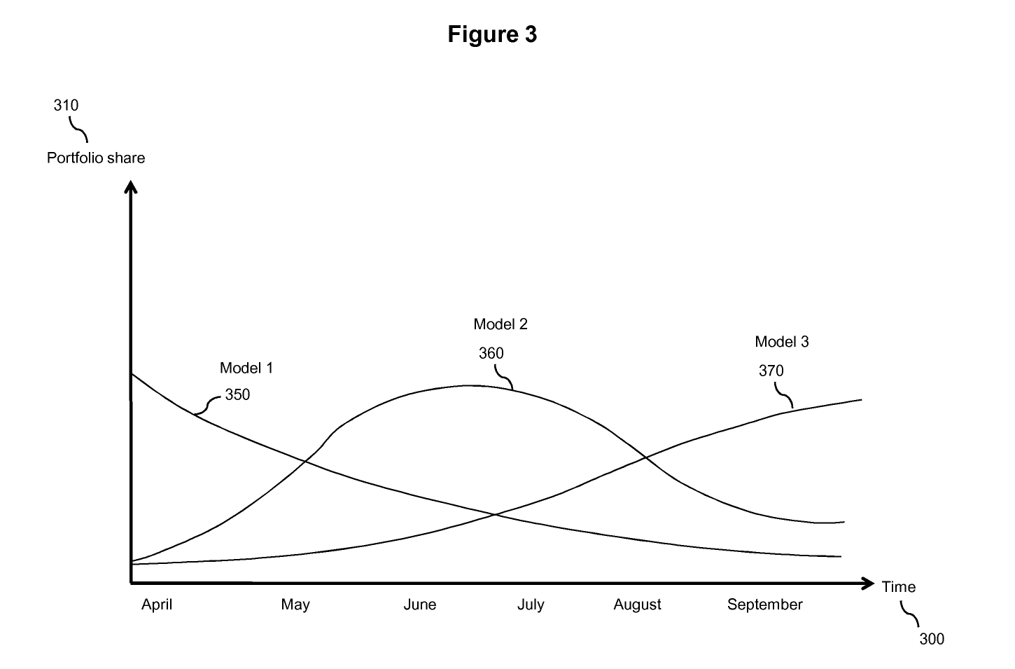

The metrics included in the list of static metrics are defined by the Mobile Operator. The analytic engine 530 is configured with this list of static metrics. The static metrics represent information needed to follow the evolution of the mobile devices portfolio share, and are requested on a regular basis by the end users of the analytic system 100, in the form of reports. The reports are presented by the report presentation unit 540 to the end users via a Graphical User Interface. Dynamic metrics are included in ad-hoc reports, and are more rarely requested by the end users of the analytic system 100 (it is not possible to anticipate all the metrics which may be generated by combining the information present in the database 520). However, a dynamic metric may be added to the list of static metrics, if the end users decide over time that it has become required information. FIG. 2 and FIG. 3 illustrate exemplary reports.

For each model of mobile device that can potentially be detected on the mobile data network 60, the analytic system 100 has a description of its characteristics and features. These are used to generate additional metrics (like the previous example of a dynamic metric based on the availability of a WIFI connection on the mobile devices). For instance, description of mobile device characteristics and features may include one or several of the following: the operating system, the maximum data throughput, the form factor, the web browser, etc. These characteristics and features are criteria that influence the portfolio share of mobile devices; especially for high end devices designed to stimulate access to various types of advanced mobile data services. These characteristics and features are stored in the database 520 and used by the analytic engine 530 to generate the additional metrics. Thus, the database 520 is updated constantly with the characteristics and features of the mobile devices that appear on the market. This can be performed via a manual upgrade. Alternatively, an external data source (500 on FIG. 5) with this type of information can be automatically queried on a regular basis by the pre-processing unit 510, to perform the necessary updates to the database 520.

Additionally, the analytic system 100 may be interfaced with an information system 120 of the Mobile Operator. This option is nice to have but the analytic system 100 shall be able to operate without it. However, some demographic information related to the subscribers of the subscribed mobile devices may be extracted from the information system 120 and used by the analytic engine 530, to correlate the portfolio share metrics with demographic information. For example, the portfolio share of different models of mobile devices may be analyzed, taking into account the gender, the age, the social category, the place of residence, of the subscribers. From an operational point of view, one way to proceed is to have the pre-processing unit 510 retrieve the demographic information from the information system 120 of the Mobile Operator (represented as an external data source 500 on FIG. 5) and load this demographic information in the database 520, to be queried by the analytic engine 530. This is an iterative process which is repeated on a regular basis, to take into account changes in the demographic information of existing subscribers, and to take into account new subscribers who have been added to the database 520.

Another important aspect of the invention is the correlation of the mobile data services usage with the models of mobile devices. The filtering system 110 captures the IP traffic generated during the data sessions of the multiple mobile devices 10, 12, 14 represented on FIG. 1. The following information is extracted from the data sessions and transmitted to the analytic system 100 (more specifically to the pre-processing unit 510 of FIG. 5): the identifier of the subscriber (for example the IMSI in the case of an UMTS network), the type(s) of mobile data services used during the data session, a timestamp identifying the beginning of each mobile data service usage, the volume of data transferred for each mobile data service, etc. Additional information characterizing the mobile data services may be added if required.

The types of mobile data services are obtained via the classification capabilities of the DPI engine of the filtering system 110. The DPI engine recognizes the type(s) of mobile data service(s) among a pre-defined set of types. Examples of such types include: browsing, messaging, video or audio streaming, on-line gaming, social networking, Voice over IP (VoIP), corporate application, etc. The DPI engine analyzes the different IP protocol layers (network, transport, session, application . . . ) of the captured IP data sessions and uses signatures to recognize a specific type of application (web browsing, Skype, Google Mail . . . ), which is associated to one of the pre-defined types of mobile data services. However, for a given type of mobile data service, like for example VoIP, different types of VoIP applications are detected by the DPI engine of the filtering system 110. The present method and system are based on the detection of the types of mobile data services by the filtering system 110 and the analysis by the analytic system 100 of these types in relation to the models of mobile devices. However, if a higher level of granularity is required, such granular information may be extracted by the filtering system 110 and analyzed by the analytic system 100 in a similar manner as previously described.

The pre-processing unit 510 of FIG. 5 receives the information collected by the filtering system 110 and stores this information in the database 520. For each mobile data service session, the pre-processing unit 510 receives the following information from the filtering system 110: the subscriber identifier, the type of mobile data service, a timestamp identifying the beginning of the session, the volume of data transferred during the session, etc. The database 520 is updated with this information based on the subscriber identifier.

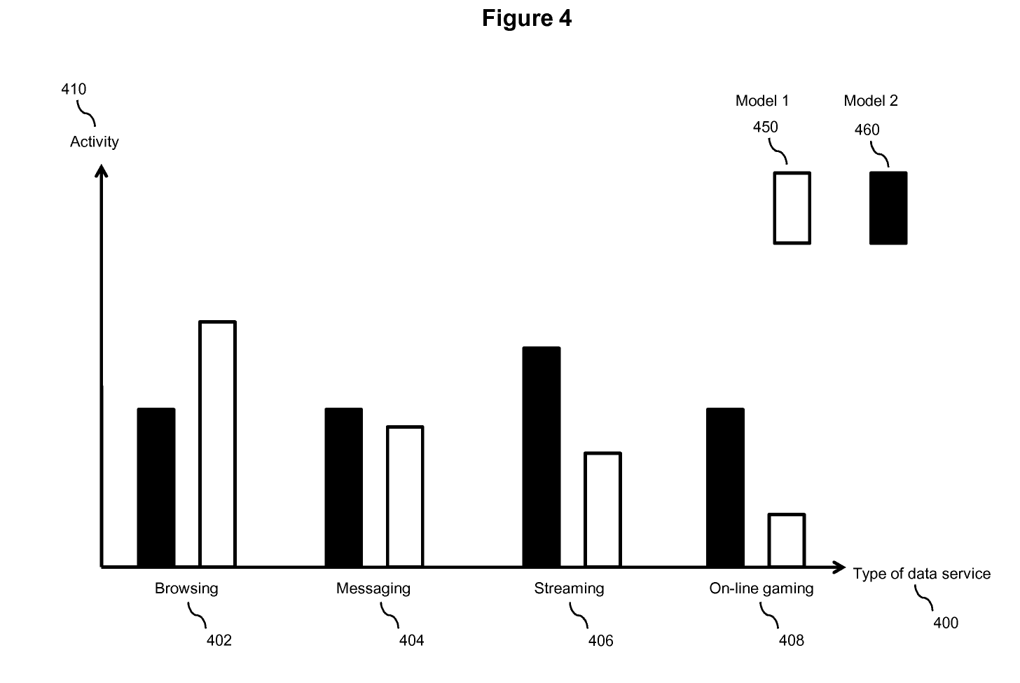

The analytic engine 530 generates metrics related to the correlation of the mobile data services usage with the models of mobile devices. The computation of the metrics has previously been described and the principles are similar to those described for the computation of the metrics related to the mobile devices portfolio share. A metric for the aforementioned correlation consists in computing the usage for a specific type of mobile data service, for a specific mobile device, over a specific period of time. The analytic engine 530 queries the database 520 to extract the relevant information and compute one or several values representing the usage for the selected parameters (type of mobile data service, model of mobile device, period of time, etc). The values are computed taking into consideration all the mobile devices subscribed to the mobile data network 60 recorded in the database 520 (as already mentioned, combinations including or excluding roaming mobile devices can be used). Three examples of types of values to represent the usage include: volume of data generated by the mobile data service over the period of reference, number of unique mobile devices or subscribers of mobile devices accessing the mobile data service over a period of reference, and frequency of usage of the mobile data service over the period of reference. These three alternative metrics to evaluate the usage of a mobile data service will be further detailed in the description of FIG. 4. Other metrics related to mobile data service and mobile data usage could further be generated using the presently described method and system.

The analytic engine 530 generates reports based on the computed metrics, to be presented to the end users by the reports presentation unit 540 of FIG. 5. To generate a report, a mobile data service and a period of reference are selected. Metrics representing the usage are computed for several models of mobile devices. The metrics are represented on the report, to allow the comparison of the usage of the mobile data service between the different models of mobile devices. The usage metrics related to several types of mobile data services can also be represented on a single report, for purpose of comparison between several services. The usage metrics can also be calculated per manufacturer (by aggregating the usage of all models of mobile devices owned by a specific manufacturer). This allows the comparison of the mobile data services usage between manufacturers of mobile devices, as depicted in FIG. 4.

FIG. 2 illustrates a type of report that is generated by the analytic system 100 of FIG. 1, performing mobile devices portfolio share analytics.

The dashboard on FIG. 2 represents the portfolio share per manufacturer. This is the type of information that is used by the Mobile Operator, to help track the trends in mobile device portfolio share on the mobile data network. In the example represented on FIG. 2, the portfolio share 210 of manufacturer 1 is the biggest with roughly 40%. It is followed by the portfolio share 220 of manufacturer 2 with roughly 25%. It is followed by the portfolio share 230 of manufacturer 3 with roughly 15%. It is followed by the portfolio share 240 of manufacturer 4 with roughly 10%. It is followed by the portfolio share 250 of the manufacturer 5 with roughly 5%. The portfolio share 260 of the remaining manufacturers is roughly 5%.

A refinement of the portfolio share represented in FIG. 2 is obtained, by extracting the information for each model of mobile device offered by the manufacturer. For example, in FIG. 2, manufacturer 1 has a portfolio share 210 of roughly 40%. It is important to know that its top performing model owns 10% on its own, the second and third performing models each own around 5%, and the 20% left are shared among the rest of the models. Based on this type of information, a dashboard is generated with the top 3 performing mobile devices for each manufacturer.

The aforementioned reports can be generated following two types of time frame. A first type of time frame is a snapshot view of the selected portfolio shares. This gives a picture of the targeted portfolio shares at a given instant, usually a specific day or week. However, in certain cases, a better granularity is useful, to follow an outstanding event taking place at a specific location (also using additional geographical information extracted by the filtering system 110 if needed). Using these snapshot views, the Mobile Operator follows the evolution of the portfolio shares on a regular basis, for example daily or weekly.

A second type of time frame is a period of time, like a week, a month, a year; or any period between two given days. The reports generated by the analytic system 100 provide the evolution of the respective portfolio shares of several manufacturers, or of several models (or groups of models) of mobile devices. The dashboard represented on FIG. 3 illustrates this type of report. The horizontal axis 300 represents the time and the vertical axis 310 the portfolio share. The evolution of the portfolio share of three models, 350, 360, 370, of mobile devices is represented over the time period. Based on this dashboard, the Mobile Operator could draw various conclusions. Model 1, 350, is a mature mobile device, which portfolio share is declining regularly over the time period. Model 2, 360, is a newly introduced mobile device. It was very popular at the beginning of the period and its portfolio share climbed very quickly, but it reached a peak rapidly and declined steadily. Model 3, 370, is also a newly introduced mobile device. This model increased its portfolio share at a slow but regular pace, and it seems to have the capability to capture a significant portfolio share over a long time period.

A large flexibility is offered in the selection of the manufacturers or mobile devices for which the reports are generated. Metrics are calculated by the analytic system 100, for any combination of manufacturers or models of mobile devices, to generate the appropriate reports, according to the Mobile Operator's needs. This capability enables the Mobile Operator to follow the competition between a few models of mobile devices addressing the same market segment.

Other metrics that are generated by the analytic system are related to the dynamics of the portfolio share evolution. For instance, when a new popular model of mobile device is introduced, a significant number of subscribers change their current model to adopt this new model. It is very interesting to track which models are abandoned. The type of dashboard presented on FIG. 2 is used to represent the relative portfolio share losses per model or manufacturer, caused by the introduction of the new model of mobile device. Using FIG. 2 as an illustration, almost 40% of the conversions to the new mobile device affect manufacturer 1, 210; almost 25% affect manufacturer 2, 220, and so on. Alternatively, the same type of metrics is applied to a model of mobile device loosing popularity. In this case, a significant number of subscribers abandon the model with a declining popularity to adopt a new model. The type of dashboard presented on FIG. 2 is used to represent the relative portfolio share gains per model or manufacturer, caused by the declining popularity of the considered mobile device.

Several more metrics representing the dynamics of the evolution of the portfolio share are generated by the analytic system 100. For example, the model or manufacturer with the highest progression in terms of gains or the highest progression in terms of losses, related to the portfolio share, are tracked.

All the aforementioned metrics addressed the portfolio share of manufacturers or models of mobile devices, considering different combinations of the manufacturers and models to generate the metrics and reports. Alternatively, a specific capability or feature of the mobile devices is tracked, to generate the same type of metrics and the associated reports.

One of these important features is the operating system of the mobile devices. Its support of advanced multimedia capabilities, ergonomics, multi-tasking, is critical to offer a good user experience when consuming mobile data services on the mobile operator data network. There is a strong competition between the leading operating systems, and they are more and more considered as an important differentiating factor, particularly for the high end mobile devices like the Personal Digital Assistants (PDA). Thus the evolution of the portfolio share of the main competing operating systems is a valuable source of marketing information for the Mobile Operator.

Another important capability is the available data rate, both uplink and downlink (the uplink data rate is usually limited compared to the downlink data rate). A mobile device with a higher data throughput is more appealing to a subscriber eager to consume advanced mobile data services. For example for Universal Mobile Telephone System (UMTS) mobile devices, the standard UMTS data rate has been improved with the introduction of evolutions. One such evolution is the High-Speed Packet Access (HSPA), which increased the uplink and downlink data rates. Then, HSPA has been further improved with the so-called HSPA+, to further improve uplink and downlink data rates The next evolution is 4G with the so-called Long Term Evolution (LTE), which will again significantly improve uplink and downlink data rates. The Mobile Operator may be interested to know the relative portfolio shares of mobile devices with standard UMTS, HSPA, HSPA+, LTE (and the following evolutions), capabilities. An increasing proportion of mobile devices with enhanced data throughputs is an opportunity to introduce new mobile data services requiring higher bandwidth. It is also an indicator that the capacity of the Mobile Operator data network should be upgraded soon.

Another important feature is the form factor of a mobile device. Today, a large array of designs are available, including bar, clamshell, flip, slide, swivel. Following the portfolio share of the various designs is a good indicator, to figure out which mobile devices have a greater chance to be among the most popular ones.

Other features of the mobile devices can be tracked. For example, the Internet browser, the e-mail client, or any other differentiating application related to mobile data services. Several different models of Internet browsers, e-mail clients, can be embarked on a model of mobile device. Thus, their portfolio share can also be analyzed and reports generated. For a given model of mobile device, the web browser and the e-mail client are pre-installed, so that these characteristics are known in advance. However, it is becoming increasingly easy to modify the software of a mobile device, so that customers may change the original web browser or e-mail client. In this case, the filtering system 110 of FIG. 1 is adapted for detecting these characteristics in real time, to have accurate information for each mobile device.

Localization information can also introduce new perspectives on the metrics that are calculated by the analytic system 100. In a particular aspect of the present method and system, the filtering system 110 of FIG. 1 is further adapted for recording a radio cell involved in each data session reported to the analytic system 100 (along with the subscriber unique identification and the model of mobile device used). The radio cell is given as an example, but any type of real time localization information that can be reported could alternately be used. The aforementioned metrics may then be calculated for each radio cell (or group of radio cells representing a geographical area of interest). Reports are generated to identify, for example, the areas where high end mobile devices (with capabilities identified as susceptible to produce more mobile data traffic or advanced mobile data services consumption) have the greatest portfolio share. This information is used to detect areas where the mobile network capabilities should be upgraded. It is also used to target areas, where advanced localization-based mobile data services have the best chance to succeed.

Another type of localization information is the city or province of residence of the subscribers. This information is used to identify the top adopters location (represented by city or province) for a new model of mobile device. The information related to the residence of the subscribers can be provided by the information system 120 of FIG. 1.

FIG. 4 illustrates still another type of report that is generated by the analytic system 100 of FIG. 1, performing a correlation between the mobile data services usage and the models of mobile devices.

The dashboard on FIG. 4 correlates the activity of different types of mobile data services with different models of mobile devices. In the example, two models are compared: a first model 450 and a second model 460. The horizontal axis represents the types of mobile data services 400. In the example, browsing 402, messaging 404, streaming 406, on-line gaming 408 are considered. The vertical axis represents the activity 410, for each type of mobile data service and each model of mobile device.

The activity is represented over a period of reference; typically a year, a month, a week, or a day. The period is selected by the end user and a report is generated by the analytic system 100. It aggregates the activity measures reported by the filtering system 110 between the beginning and the end of the period of reference. If a more real time view is required, the granularity may be in hours or even minutes. However, a better granularity involves more processing from the analytic system 100 and thus requires more powerful components (the database 520 and the analytic engine 530 of FIG. 5). As an example, if the duration selected by the end user to generate the report is the month of March 2009, then the dashboard represented on FIG. 4 represents the cumulative activity of March 2009 for browsing 402, messaging 404, streaming 406 and on-line gaming 408.

The type of mobile data service 400 could include one or several of the following: browsing, messaging, streaming (audio and video), broadcasting (e.g. mobile TV or radio), on-line gaming, social networking, VoIP, professional services (e.g. secure e-mail, video-conferencing, productivity applications), etc. The end user has the capability to select a subset of all available mobile data services, to be represented on a report of the type displayed in FIG. 4.

A large flexibility is provided by the analytic system 100 for the comparison between the models of mobile devices. Two or more models may be compared within the same report. For simplicity, in FIG. 4, only two models 450 and 460 of mobile devices are represented. Alternatively, a single model may be compared against a category including several models. For instance, a model is compared against all the available models, or against all the models distributed by its manufacturer. For this purpose, the analytic system 100 aggregates all the activity measures 410 of the models included in a specific category, to generate the report.

Different metrics are used to measure the activity 410 represented on FIG. 4. The volume of data transmitted during the data sessions associated to a type of mobile data service is one possibility. Alternatively, the average volume of data per mobile data session or any other data corresponding to usage of the data service could be used.

A percentage of unique subscribers accessing the mobile data service over the period of reference is another metric supported by the analytic system 100 to measure the activity 410. In this context, a unique subscriber is defined as a subscriber using the mobile data service at least once over the period of reference. The fact that this subscriber uses the mobile data service several times is not relevant (this case is taken into account by another metric, the frequency, which will be introduced later). For example, the streaming data service 406 could be considered over a period of reference of one day. The activity 410 for the model 450 in terms of percentage of unique subscribers is the number of subscribers owning the model 450, which have used at least once the streaming data service during the selected day, divided by the total number of subscribers owning the model 450, expressed in percentage. This notion of unique subscriber may not be relevant for mobile data services used frequently by most subscribers, like browsing. But for a new mobile data service recently deployed by a Mobile Operator, it is a very interesting metric to follow the adoption rate of the service, correlated to the model of mobile device.

Analyzing the dashboard given as example on FIG. 4, the Mobile Operator may discover several trends. The first model 450 is more extensively used for browsing than the second model 460. On the other side, the second model is more extensively used for streaming and on-line gaming than the first one. One can infer that the second model is better suited for multimedia oriented mobile data services. Additionally, the two models have a similar usage in terms of messaging and cannot be differentiated with respect to this type of data service.

Another type of possible dashboard is the comparison of the evolution of the activity of a type of mobile data service over a time period for different models of mobile devices. The period (week, month, year) over which the comparison is performed is represented on the horizontal axis. The vertical axis represents the activity of the selected type of mobile data service (the streaming activity for example). The metrics to measure the activity are those introduced for FIG. 4 (volume of data or unique subscribers). The activity is represented for two or more models of mobile devices to be compared. Analyzing this type of dashboard, the Mobile Operator can discover which models of mobile devices are most likely to boost the consumption of the type of mobile data service analyzed (for example streaming).

One additional metric supported by the analytic system 100 is the frequency. It consists in comparing the frequency of use of a selected type of mobile data service between several models of mobile devices, over a selected time period. For example, considering a time period of one day, the following frequencies are introduced: once, twice, three to five times, six to ten times, and more than then times. For each model of mobile device selected, the percentage of mobile devices of this model using the mobile data service (e.g. streaming) at each of the frequencies is calculated. This enables the Mobile Operator to detect which models of mobile devices generate the most frequent consumption of the mobile data service.

Reports identifying the most active and most inactive models of mobile devices are also generated by the analytic system 100. Such a report compares the activity for a given mobile data service over a selected time period. As already stated, the activity may be measured in terms of volume of data, unique subscribers or any other appropriate criteria. Dashboards with, for example, the top five active models and the top five inactive models are displayed.

The activity for a given mobile data service is also correlated to specific characteristics of the mobile devices. Such characteristics include, among others: the size of the screen, the resolution of the camera, the form factor, the operating system, the uplink and downlink data rate . . . For instance, the mobile devices are divided into several categories of screen size, and the activity in term of streaming is compared between these categories. This comparison is relevant since the size of the screen has an impact on any multimedia based mobile data service.

FIG. 5 illustrates an embodiment of the system architecture of the analytic system 100 for performing mobile devices portfolio share analytics.

As represented on FIG. 5, the analytic system 100 introduced in FIG. 1 is composed of the following sub-entities: a pre-processing unit 510, a database 520, an analytic engine 530, a reports presentation unit 540, and an end-user control interface 550.

The analytic system 100 receives data from the filtering system 110. As already explained, several instances of the filtering system 110 may be deployed in different parts of the mobile data network 60 of FIG. 1. Each instance reports real time data to the analytic system 100. In case the volume of data to handle is too large, the analytic system 100 may also be split between several instances, to scale. Optionally, the analytic system 100 receives data from several external data sources 500. One of the external data sources 500 is the Network Operator information system 120 (mentioned in FIG. 1). Another external data source 500 is a server or a database, with the detailed descriptions in terms of features and capabilities, of all models of mobile devices available on the market.

The pre-processing unit 510 is composed of dedicated software executed on a computer, to process the information received from the filtering system 110 and the external data sources 500, and update the database 520 when necessary. As already explained, in the case of the information transmitted by the filtering system 110 of FIG. 1, the pre-processing unit 510 queries the database 520 and an update of the database 520 is triggered by the detection of a new model of mobile device used by a subscriber. Optionally, the pre-processing unit 510 manages roaming mobile devices and the related updates to the database 520, to track the corresponding models of mobile devices. A timestamp is associated with all types of updates to the database 520, to include a time dimension in the metrics generated by the analytic engine 530. The pre-processing unit 510 also updates the database 520 with data related to the mobile data services usage of the subscribers (type of mobile data service, timestamp associated to the usage, volume of data transferred associated to a specific subscriber via its identifier) and roaming mobile devices if desired.

The database 520 is a traditional database. It is managed by the pre-processing unit 510 and is the source of information for the analytic engine 530. There is a strong requirement on the performances of the database 520 in terms of volume of data to store and computing power for the treatment of these data, since tens of millions of subscribers may have to be managed for large Mobile Operators.

The analytic engine 530 is the core of the analytic system 100. It is an applicative software executed on a computer, to generate the various metrics that have been detailed in the previous sections. The information contained in the database 520 is queried, aggregated and processed by the analytic engine 530 to generate the metrics (essentially various types of portfolio shares applied to models, manufacturers, characteristics and capabilities, of mobile devices and also mobile data services usage correlated to the models of mobile devices). Subsets of the metrics are extracted by the reports presentation unit 540 and presented to the end user in the form of dashboards.

The reports presentation unit 540 consists in a Graphical User Interface on a computer, to present different types of reports to the end user. The reports are presented in the form of dashboards combining pre-defined information computed by the analytic engine 530 (the reports are generated by the analytic engine 530 and are based on the computed metrics). A pre-defined list of reports is included by default in the analytic engine 530. Some new reports can also be defined, using the end user control interface 550.

The end user control interface 550 also consists in a Graphical User Interface on a computer. It offers two levels of interaction to the end users. Standard end users only interact with the reports presentation unit 540, to request the generation of a report selected among the list of pre-defined available reports. When such a report is presented, the standard end user interacts with the report to modify a limited number of parameters and variables, and dynamically update the report. For instance, such a report is the relative portfolio share of several models of mobile devices over a time period. The end user has the ability to select and modify the following parameters: the models to be compared among a pre-defined list and the time period to consider. The report is then automatically updated with the proper information computed by the analytic engine 530.

Advanced end users have the same level of interaction with the reports presentation unit 540 as the standard end users. In addition, advanced end users are allowed to interact directly with the analytic engine 530. This capability enables an advanced end user to define a new (dynamic or static) report that is generated by the analytic engine 530 and presented to standard and advanced end users on the reports presentation unit 540. For this purpose, the advanced end user selects which (dynamic) metrics are aggregated to generate the report and the analytic engine 530 performs the necessary computation to prepare the data that will be necessary when the report is requested by the reports presentation unit 540. A dynamic report may be later added to the list of pre-defined reports.

Typical end users consist in members of the marketing team and possibly the network management team of the Mobile Operator.

Although the present method and system have been described in the foregoing specification by means of several non-restrictive illustrative embodiments, these illustrative embodiments can be modified at will within the scope, spirit and nature of the subject invention.

What is claimed is:

1. A method for analyzing a mobile operator data network, the method comprising:
collecting in real time information about mobile devices from Internet Protocol data sessions occurring in the mobile operator data network;
recording the collected information in a database;
processing the collected information to detect at least one change in one of the mobile devices;
recording the at least one change for the corresponding mobile device and a date of occurrence; and
analyzing the collected information and the recorded at least one change to generate metrics.

2. The method of claim 1, wherein the processing, recording, and analyzing are performed by a centralized analytic system, and the collecting is performed by at least one filtering system located in the mobile operator data network.

3. The method of claim 1, wherein the metrics are representative of the evolution of mobile devices portfolio in accordance with one of the following: manufacturer, model, type of mobile service, or a characteristic of the mobile devices.

4. The method of claim 1, wherein the information about mobile devices collected in real time includes at least one of the following: a unique identifier of the mobile device, a unique identifier of the model of the mobile device, a timestamp, a type of mobile service, a volume of data transmitted.

5. The method of claim 3, wherein the metrics measure at least one of the following: a portfolio share of the mobile devices for various models of mobile devices or for all models of mobile devices of a manufacturer.

6. The method of claim 3, wherein the metrics are used to generate reports comparing portfolio share at a given moment or to compare an evolution of the portfolio share on a given period of time.

7. The method of claim 6, wherein the metrics further generate reports of the portfolio share in function of a characteristic of the mobile devices, comprising: form factor, operating system, mobile web browser, uplink and downlink data rates, and screen size.

8. The method of claim 1, further comprising differentiating mobile devices corresponding to subscribers of the mobile operator data network from mobile devices corresponding to roaming mobile devices

9. The method of claim 8, wherein the analyzing of the collected information further considers the mobile devices corresponding to subscribers of the mobile operator data network and the mobile devices corresponding to roaming mobile devices so as to generate metrics representative of subscribers only, of roamers only, or for both subscribers and roamers.

10. (canceled)

11. The method of claim 1, wherein the metrics are used to generate reports identify among a portfolio of models of mobile devices top performers in terms of gain of market share or least performers in terms of loss of market share over a specific period of time.

12. (canceled)

13. (canceled)

14. An analytic system for analyzing a mobile operator data network, the system comprising:
an pre-processing unit for receiving information about mobile devices collected in real time from Internet Protocol data sessions occurring in the mobile operator data network, the pre-processing unit detecting at least one change in one of the mobile devices and recording the at least one change for the corresponding mobile device and a date of occurrence;
a database for recording the collected information, the at least one change for the corresponding mobile device and the date of occurrence; and
an analytic engine for analyzing the collected information and the recorded at least one change to generate metrics.

15. The system of claim 14, wherein the metrics are representative of the evolution of mobile devices portfolio in accordance with one of the following: manufacturer, model, type of mobile service, or a characteristic of the mobile devices.

16. The system of claim 14, wherein the information about mobile devices collected in real time includes at least one of the following: a unique identifier of the mobile device, a unique identifier of the model of the mobile device, a timestamp, a type of mobile service, and a volume of data transmitted.

17. The system of claim 16, wherein the metrics measure at least one of the following: a portfolio share of the mobile devices for various models of mobile devices or for all models of mobile devices of a manufacturer.

18. The system of claim 16, wherein the system further comprises a report presentation unit for generating reports from the metrics comparing portfolio share at a given moment or to compare an evolution of the portfolio share on a given period of time.

19. The system of claim 18, wherein the report presentation unit further generates reports of the portfolio share in function of a characteristic of the mobile devices, comprising: form factor, operating system, mobile web browser, uplink and downlink data rates, and screen size.

20. The system of claim 14, wherein the pre-processing unit further differentiates mobile devices corresponding to subscribers of the mobile operator data network from mobile devices corresponding to roaming mobile devices

21. The system of claim 20, wherein the analytic engine further considers the mobile devices corresponding to subscribers of the mobile operator data network and the mobile devices corresponding to roaming mobile devices so as to generate metrics representative of subscribers only, of roamers only, or for both subscribers and roamers.

22. The system of claim 14, wherein the system further comprises a report presentation unit for generating reports from the metrics.

23. The system of claim 22, wherein the reports identify among a portfolio of models of mobile devices top performers in terms of gain of market share or least performers in terms of loss of market share over a specific period of time.

24. (canceled)

25. (canceled)

26. (canceled)
